(19) United States
(12) Patent Application Publication
(10) Pub. No.: US 2024/0128492 A1
(43) Pub. Date: Apr. 18, 2024

(54) NON-AQUEOUS ELECTROLYTIC SOLUTION FOR LITHIUM ION SECONDARY CELL

(71) Applicant: TOYOTA JIDOSHA KABUSHIKI KAISHA, Toyota-shi (JP)

(72) Inventors: Akira KOHYAMA, Toyota-shi (JP); Hiroto ASANO, Nisshin-shi (JP); Shimpei KONDO, Nagoya-shi, (JP)

(73) Assignee: TOYOTA JIDOSHA KABUSHIKI KAISHA, Toyota-shi (JP)

(21) Appl. No.: 18/395,955

(22) Filed: Dec. 26, 2023

Related U.S. Application Data
(63) Continuation of application No. 16/573,253, filed on Sep. 17, 2019.

(30) Foreign Application Priority Data
Jun. 9, 2018 (JP) 2018-176495

(51) Int. Cl. H01M 10/0525; H01M 4/133; H01M 4/583; H01M 4/62; H01M 10/0567; H01M 10/0569

(52) U.S. Cl. CPC H01M 10/0525; H01M 4/133; H01M 4/5835; H01M 4/623; H01M 10/0567; H01M 10/0569; H01M 2220/20; H01M 2300/0034

(57) ABSTRACT

Provided is a non-aqueous electrolytic solution for a lithium ion secondary cell that uses an additive that can suppress gas generation due to the decomposition of the non-aqueous electrolytic solution and has a low environmental risk. The non-aqueous electrolytic solution for a lithium ion secondary cell disclosed herein includes an electrolyte salt including a fluorine atom, a non-aqueous solvent capable of dissolving the electrolyte salt, and at least one heteroaromatic dicarboxylic acid anhydride selected from the group consisting of a compound represented by a following formula (I) and a compound represented by a following formula (II) as an additive (wherein, R1 to R7 are as defined in the specification):

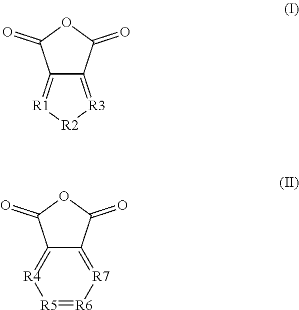

### CROSS-REFERENCE

This is a continuation of U.S. application Ser. No. 16/573,253 filed Sep. 17, 2019, which claims priority to Japanese Patent Application No. 2018-176495 filed Sep. 20, 2018, the entire contents of each being incorporated by reference herein in their respectively entireties.

### BACKGROUND OF THE INVENTION

### 1. Field of the Invention

The present teaching relates to a non-aqueous electrolytic solution for a lithium ion secondary cell.

### 2. Description of the Related Art

In recent years, lithium ion secondary cells have been suitably used for portable power sources such as personal computers and portable terminals, and power sources for driving vehicles such as electric vehicles (EVs), hybrid vehicles (HVs) and plug-in hybrid vehicles (PHVs).

It is known that in a lithium ion secondary cell, gas is generated by decomposition of a non-aqueous electrolytic solution. Where gas is generated, the internal pressure of the lithium ion secondary cell rises. Where the amount of gas increases and internal pressure greatly rises due to long-term use, storage at high temperature, and the like, the cell cannot be further used due to deformation of the cell case or early activation of a pressure-sensitive safety mechanism such as a current interrupt device and a safety valve. Therefore, from the viewpoint of prolonging the life of the lithium ion secondary cell, it is desirable that the generation of gas due to the decomposition of the non-aqueous electrolytic solution be suppressed. Accordingly, Japanese Patent No. 6167548 suggests adding an isocyanate compound to a non-aqueous electrolytic solution in order to suppress gas generation due to the decomposition of the non-aqueous electrolytic solution.

### SUMMARY OF THE INVENTION

However, since isocyanate compounds are relatively toxic, it is desirable from the environmental standpoint that their use be avoided as much as possible. Therefore, it is desired to develop a non-aqueous electrolytic solution for a lithium ion secondary cell that uses an additive that can suppress gas generation due to the decomposition of the non-aqueous electrolytic solution and has a low environmental risk.

Accordingly, an object of the present teaching is to provide a non-aqueous electrolytic solution for a lithium ion secondary cell that uses an additive that can suppress gas generation due to the decomposition of the non-aqueous electrolytic solution and has a low environmental risk.

The non-aqueous electrolytic solution for a lithium ion secondary cell disclosed herein includes an electrolyte salt including a fluorine atom, a non-aqueous solvent capable of dissolving the electrolyte salt, and at least one heteroaromatic dicarboxylic acid anhydride selected from the group consisting of a compound represented by the following formula (I) and a compound represented by the following formula (II) as an additive.

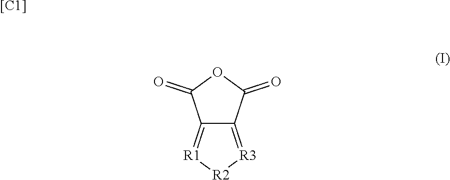

(wherein, R1 and R3 independently represent CH or N, R2 represents CH₂, NH, O or S, and any one or two of R1, R2 and R3 include a heteroatom to constitute a conjugated ring).

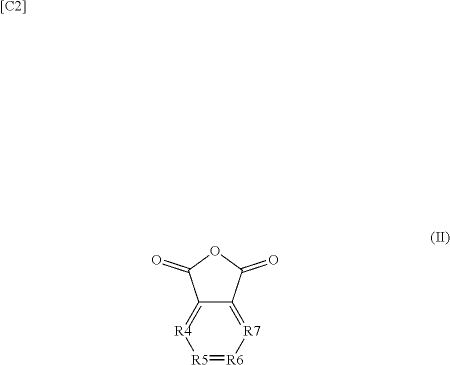

(wherein, R4 to R7 independently represent CH or N, and any one or any two of R4 to R7 are N).

According to such a configuration, it is possible to provide a non-aqueous electrolytic solution for a lithium ion secondary cell that uses an additive that can suppress gas generation due to the decomposition of the non-aqueous electrolytic solution and has a low environmental risk.

In a desired embodiment of the non-aqueous electrolytic solution for a lithium ion secondary cell disclosed herein, the non-aqueous electrolytic solution for a lithium ion secondary cell further includes fluoroethylene carbonate.

The advantage of such a configuration is that the capacity deterioration of the lithium ion secondary cell can be suppressed.

In a desired embodiment of the non-aqueous electrolytic solution for a lithium ion secondary cell disclosed herein, the heteroaromatic ring of the heteroaromatic dicarboxylic acid anhydride includes a nitrogen atom.

With such a configuration, the effect of suppressing gas generation due to the decomposition of the non-aqueous electrolytic solution is particularly enhanced.

A lithium ion secondary cell disclosed herein includes the above-described non-aqueous electrolytic solution for a lithium ion secondary cell.

With such a configuration, since the generation of gas due to the decomposition of the non-aqueous electrolytic solution is suppressed, a lithium ion secondary cell having a long life can be provided. In addition, in the lithium ion secondary cell, the environmental risk of the non-aqueous electrolytic solution is reduced.

### BRIEF DESCRIPTION OF THE DRAWINGS

FIG. 1 is a cross-sectional view schematically showing the internal structure of a lithium ion secondary cell using a non-aqueous electrolytic solution according to an embodiment of the present teaching; and

FIG. 2 is a schematic view showing a configuration of a wound electrode body of a lithium ion secondary cell using a non-aqueous electrolytic solution according to an embodiment of the present teaching.

### DESCRIPTION OF THE PREFERRED EMBODIMENTS

Hereinafter, embodiments of the present teaching will be described. In the present specification, any features other than matters specifically mentioned in the present specification and that may be necessary for carrying out the present teaching (for example, the general configuration of the non-aqueous electrolytic solution for lithium ion secondary cell and manufacturing process which do not characterize the present teaching) can be understood as design matters for a person skilled in the art which are based on the related art. The present teaching can be implemented based on the contents disclosed in the present specification and common technical knowledge in the field.

In the present specification, the term “secondary cell” refers to a repeatedly chargeable and dischargeable storage device in general, and is a term inclusive of storage devices such as so-called storage cells and electric double layer capacitors.

Further, in the present specification, the term “lithium ion secondary cell” refers to a secondary cell in which lithium ions are used as charge carriers and charge and discharge are realized by the movement of charges associated with lithium ions between positive and negative electrodes.

A non-aqueous electrolytic solution for a lithium ion secondary cell according to the present embodiment includes an electrolyte salt including a fluorine atom, a non-aqueous solvent capable of dissolving the electrolyte salt, and at least one heteroaromatic dicarboxylic acid anhydride selected from the group consisting of a compound represented by the following formula (I) and a compound represented by the following formula (II) as an additive.

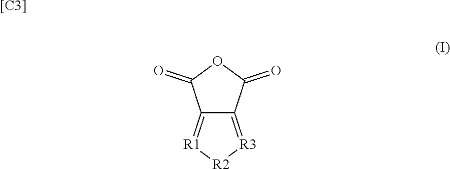

(wherein, R1 and R3 independently represent CH or N, R2 represents CH₂, NH, O or S, and any one or two of R1, R2 and R3 include a heteroatom to constitute a conjugated ring).

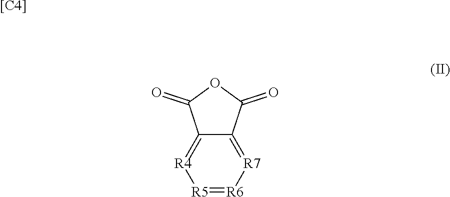

(wherein, R4 to R7 independently represent CH or N, and any one or any two of R4 to R7 are N).

An electrolyte salt which has been used for lithium ion secondary cells can be used without particular limitation as the electrolyte salt including a fluorine atom. The electrolyte salt including a fluorine atom is desirably a lithium salt including a fluorine atom. Examples of the lithium salt include LiPF₆, LiBF₄, lithium bis(fluorosulfonyl)imide (LiFSI), lithium bis(trifluoromethane)sulfonimide (LiTFSI) and the like. These can be used singly or in combination of two or more types thereof.

The concentration of the electrolyte salt in the non-aqueous electrolytic solution may be determined, as appropriate, according to the type of the electrolyte salt. The concentration of the electrolyte salt in the non-aqueous electrolytic solution is typically 0.5 mol/L or more and 5 mol/L or less, and desirably 0.7 mol/L or more and 2.5 mol/L or less.

The non-aqueous solvent dissolves the above-mentioned electrolyte salt. The type of non-aqueous solvent is not particularly limited as long as it can dissolve the above-mentioned electrolyte salt, and carbonates, ethers, esters, nitriles, sulfones, lactones, or the like which have been used in electrolytic solutions for lithium ion secondary cells can be used. Among them, a carbonate is desirable. Examples of the carbonate include ethylene carbonate (EC), propylene carbonate (PC), diethyl carbonate (DEC), dimethyl carbonate (DMC), ethyl methyl carbonate (EMC) and the like. These can be used singly or in combination of two or more types thereof.

In the present embodiment, at least one heteroaromatic dicarboxylic acid anhydride selected from the group consisting of a compound represented by the above formula (I) and a compound represented by the above formula (II) is used as an additive. These can be used singly or in combination of two or more types thereof.

In the compound represented by the formula (I), any one or two of R1, R2 and R3 include a heteroatom to constitute a conjugated ring. That is, one or two of three conditions (a) to (c): (a) R1 is N, (b) R2 is NH, O, or S, (c) R3 is N are satisfied, and a conjugated ring is constituted by two carbon atoms of the succinic anhydride skeleton which are adjacent to R1 and R3, R1, R2, and R3. Therefore, a heteroaromatic ring is formed by the two carbon atoms of the succinic anhydride skeleton adjacent to R1 and R3, R1, R2 and R3. Examples of the heteroaromatic ring include a pyrrole ring, a furan ring, a thiophene ring, a pyrazole ring, an isoxazole ring, and an isothiazole ring.

In the compound represented by the formula (II), any one or any two of R4 to R7 are N. Thus, a heteroaromatic ring is formed by two carbon atoms of the succinic anhydride skeleton adjacent to R4 and R7 and R4 to R7. Examples of the heteroaromatic ring include a pyridine ring, a pyridazine ring, a pyrimidine ring, and a pyrazine ring.

It is desirable that the heteroaromatic ring of the heteroaromatic dicarboxylic acid anhydride include a nitrogen atom because the effect of suppressing gas generation due to the decomposition of the non-aqueous electrolytic solution is particularly enhanced. That is, it is desirable that the heteroaromatic dicarboxylic acid anhydride be a compound represented by the formula (I) and a compound represented by the formula (II) that includes N as a heteroatom. The heteroaromatic dicarboxylic acid anhydride is more desirably a compound represented by the formula (II).

The addition amount of the heteroaromatic dicarboxylic acid anhydride in the non-aqueous electrolytic solution is not particularly limited as long as the effects of the present teaching are exhibited. Where the addition amount is too low, the effects of the present teaching are hardly obtained, so the addition amount is desirably 0.1% by mass or more, more desirably 0.3% by mass or more, and still more desirably 0.5% by mass or more. Meanwhile, where the concentration is too high, there is a possibility that capacity deterioration at high temperature and the like may occur, so the addition amount is desirably 3% by mass or less, more desirably 1.5% by mass or less, and still more desirably 1% by mass or less.

By using the above-mentioned heteroaromatic dicarboxylic acid anhydride as an additive to the non-aqueous electrolytic solution, it is possible to suppress the generation of gas due to the decomposition of the non-aqueous electrolytic solution.

The inventors of the present teaching have actually produced a lithium ion secondary cell using a non-aqueous electrolytic solution including the heteroaromatic dicarboxylic acid anhydride as an additive, and conducted various analyses. As a result, in X-ray electron spectroscopy (XPS) analysis, it was found that a coating film including a heteroatom such as N and S was formed on the surface of a positive electrode active material.

Therefore, the reason why the above effects can be obtained is considered as follows.

A coating film is formed on the surface of the positive electrode active material due to the decomposition of the non-aqueous electrolytic solution, but at the time of formation of the coating film, the heteroaromatic moiety of the heteroaromatic dicarboxylic acid anhydride is incorporated into the coating film, and as a result, the coating film is modified. The further decomposition of the non-aqueous electrolytic solution in the positive electrode is thereby suppressed, and the generation of gas is suppressed.

Further, the heteroaromatic dicarboxylic acid anhydride is less toxic than the isocyanate compounds used in the related art. Therefore, the non-aqueous electrolytic solution for a lithium ion secondary cell according to the present embodiment uses an additive with a low environmental risk.

The non-aqueous electrolytic solution for a lithium ion secondary cell according to the present embodiment may further include fluoroethylene carbonate (FEC). In this case, capacity deterioration of the lithium ion secondary cell can be suppressed. In particular, since the capacity may be easily deteriorated by the addition of the heteroaromatic dicarboxylic acid anhydride to the non-aqueous electrolytic solution, the significance of combining the heteroaromatic dicarboxylic acid anhydride with fluoroethylene carbonate is high when improving the overall cell characteristics.

The addition amount of fluoroethylene carbonate in the non-aqueous electrolytic solution is not particularly limited as long as the effects of the present teaching are not significantly impaired, and the addition amount is desirably 0.5% by mass or more and 50% by mass or less, and more desirably 8% by mass or more and 20% by mass or less.

The non-aqueous electrolytic solution for a lithium ion secondary cell according to the present embodiment may include for example, a gas generating agent such as biphenyl (BP) or cyclohexylbenzene (CHB), a film-forming agent, a dispersant, a thickener, and the like as long as the effects of the present teaching are not significantly impaired.

The non-aqueous electrolytic solution for a lithium ion secondary cell according to the present embodiment can be used for a lithium ion secondary cell according to a known method. In the lithium ion secondary cell including the non-aqueous electrolytic solution for a lithium ion secondary cell according to the present embodiment, gas generation due to the decomposition of the non-aqueous electrolytic solution is suppressed. Therefore, the internal pressure rises in long-term use, storage at high temperature, and the like is suppressed, and the lithium ion secondary cell has long life. Further, in the lithium ion secondary cell including the non-aqueous electrolytic solution for a lithium ion secondary cell according to the present embodiment, the environmental risk of the non-aqueous electrolytic solution is reduced.

An outline of a configuration example of a lithium ion secondary cell using the non-aqueous electrolytic solution for a lithium ion secondary cell according to the present embodiment will be described below with reference to the drawings. In the following drawings, the same reference numerals are given to members and parts that exhibit the same action. In addition, dimensional relationships (length, width, thickness, and the like) in the drawings do not reflect actual dimensional relationships.

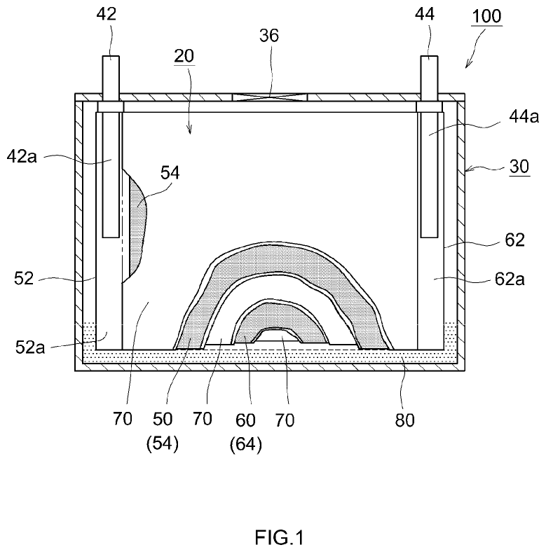

A lithium ion secondary cell 100 shown in FIG. 1 is a sealed cell constructed by housing a flat-shaped wound electrode body 20 and an electrolytic solution 80 in a flat angular cell case (that is, an outer container) 30. The cell case 30 is provided with a positive electrode terminal 42 and a negative electrode terminal 44 for external connection, and a thin-walled safety valve 36 designed to release the internal pressure when the internal pressure of the cell case 30 rises above a predetermined level. Further, the cell case 30 is provided with an injection port (not shown) for injecting the electrolytic solution 80. The positive electrode terminal 42 is electrically connected to a positive electrode current collector plate 42a. The negative electrode terminal 44 is electrically connected to a negative electrode current collector plate 44a. As a material of the cell case 30, for example, a lightweight and thermally conductive metal material such as aluminum is used.

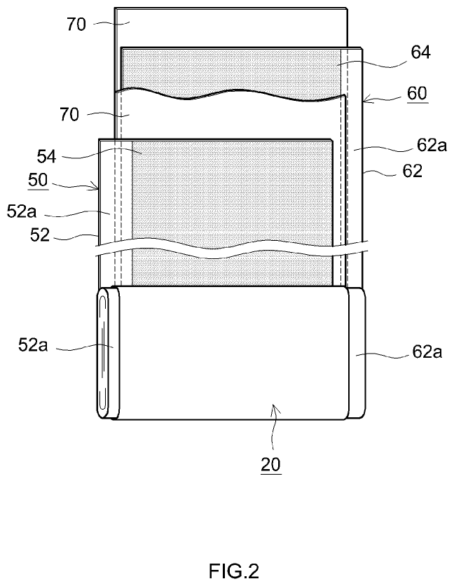

As shown in FIGS. 1 and 2, the wound electrode body 20 has a form obtained by laminating a positive electrode sheet 50 in which a positive electrode active material layer 54 is formed along the longitudinal direction on one side or both sides (here, both sides) of an elongated positive electrode current collector 52, and a negative electrode sheet 60 in which a negative electrode active material layer 64 is formed along the longitudinal direction on one side or both sides (here, both sides) of an elongated negative electrode current collector 62, with two elongated separator sheets 70 being interposed therebetween, and by winding then the resulting laminate in the longitudinal direction. The positive electrode current collector plate 42a and the negative electrode current collector plate 44a are joined respectively to a positive electrode active material layer non-formation portion 52a (that is, a portion where the positive electrode active material layer 54 is not formed and the positive electrode current collector 52 is exposed) and a negative electrode active material layer non-formation portion 62a (that is, a portion where the negative electrode active material layer 64 is not formed and the negative electrode current collector 62 is exposed) which are formed to protrude outward from both ends of the wound electrode body 20 in the winding axis direction (that is, the sheet width direction orthogonal to the longitudinal direction).

As the positive electrode sheet 50 and the negative electrode sheet 60, sheets similar to those used in the conventional lithium ion secondary cells can be used without particular limitation. One typical embodiment is shown below.

Examples of the positive electrode current collector 52 constituting the positive electrode sheet 50 include an aluminum foil and the like. The positive electrode active material contained in the positive electrode active material layer 54 is, for example, a lithium transition metal oxide (for example, LiNi_{1/3}Co_{1/3}Mn_{1/3}O₂, LiNiO₂, LiCoO₂, LiFeO₂, LiMn₂O₄, LiNi_{0.5}Mn_{1.5}O₄ and the like), a lithium transition metal phosphoric acid compound (for example, LiFePO₄ and the like) and the like. The positive electrode active material layer 54 can include components other than the active material, such as a conductive material, a binder, and the like. As the conductive material, for example, carbon black such as acetylene black (AB) and other carbon materials (for example, graphite and the like) can be suitably used. As a binder, for example, polyvinylidene fluoride (PVDF) and the like can be used.

Examples of the negative electrode current collector 62 constituting the negative electrode sheet 60 include a copper foil and the like. As a negative electrode active material contained in the negative electrode active material layer 64, for example, a carbon material such as graphite, hard carbon, soft carbon, and the like; lithium titanate (Li₄Ti₅O₁₂:LTO); Si; Sn and the like can be used. The negative electrode active material layer 64 may include a component other than the active material, such as a binder and a thickener. As the binder, for example, styrene butadiene rubber (SBR) can be used. As a thickener, for example, carboxymethylcellulose (CMC) and the like can be used.

The separator 70 can be exemplified by a porous sheet (film) made of a resin such as polyethylene (PE), polypropylene (PP), a polyester, cellulose, a polyamide and the like. The porous sheet may have a single layer structure, or may have a laminated structure including two or more layers (for example, a three-layer structure in which a PP layer is laminated on both sides of a PE layer). A heat-resistant layer (HRL) may be provided on the surface of the separator 70.

As the electrolytic solution 80, the above-described non-aqueous electrolytic solution for a lithium ion secondary cell according to the present embodiment is used. Note that FIG. 1 does not strictly indicate the amount of the electrolytic solution 80 injected into the cell case 30.

The lithium ion secondary cell 100 configured as described above can be used for various applications. Suitable applications include driving power supplies mounted on vehicles such as an electric vehicle (EV), a hybrid vehicle (HV), a plug-in hybrid vehicle (PHV) and the like. The lithium ion secondary cell 100 can also be used in the form of a cell pack typically formed by connecting a plurality of cells in series and/or in parallel.

The angular lithium ion secondary cell 100 provided with the flat-shaped wound electrode body 20 was explained as an example. However, the lithium ion secondary cell can also be configured as a lithium ion secondary cell provided with a stacked type electrode assembly. The lithium ion secondary cell can also be configured as a cylindrical lithium ion secondary cell, a laminate type lithium ion secondary cell, or the like.

Examples relating to the present teaching are described hereinbelow, but the present teaching is not intended to be limited to the features disclosed in the examples.

Preparation of Electrolytic Solutions of Examples and Comparative Examples

As a non-aqueous solvent, a mixed solvent including ethylene carbonate (EC), dimethyl carbonate (DMC) and ethyl methyl carbonate (EMC) at a volume ratio of EC:DMC:EMC=30:40:30 was prepared. In this mixed solvent, the additives shown in Table 1 were dissolved in the addition amounts shown in Table 1, and LiPF₆ was dissolved at a concentration of 1.0 mol/L. In Examples 7 to 12 and Comparative Example 2, fluoroethylene carbonate (FEC) was further added to the mixed solvent in the amount shown in Table 1. Thus, non-aqueous electrolytic solutions for lithium ion secondary cells of Examples 1 to 12 and Comparative Examples 1 and 2 were prepared.

In Table 1, the additive (A) is 2,3-pyridinedicarboxylic acid anhydride, and the additive (B) is 3,4-thiophenedicarboxylic acid anhydride. The chemical structures of the additive (A) and the additive (B) are shown below.

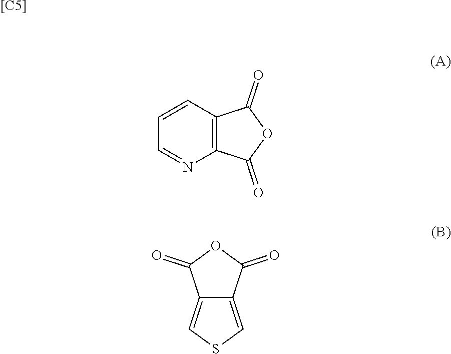

Preparation of Lithium Ion Secondary Cell for Evaluation

LiNi_{1/3}Co_{1/3}Mn_{1/3}O₂ (LNCM) as a positive electrode active material powder, acetylene black (AB) as a conductive material, and polyvinylidene fluoride (PVdF) as a binder were taken at a mass ratio of LNCM:AB:PVdF=87:10:3 and mixed with N-methylpyrrolidone (NMP) to prepare a slurry for forming a positive electrode active material layer. The slurry was coated in a strip shape on both sides of a long aluminum foil, dried, and then roll-pressed to produce a positive electrode sheet.

As a negative electrode active material, natural graphite (C) having an average particle diameter of 20 μm, styrene butadiene rubber (SBR) as a binder, and carboxymethyl cellulose (CMC) as a thickener were taken at a mass ratio of C:SBR:CMC=98:1:1 and mixed with ion-exchange water to prepare a slurry for forming a negative electrode active material layer. The slurry was coated in a strip shape on both surfaces of a long copper foil, dried, and then roll-pressed to produce a negative electrode sheet.

Further, two separator sheets (a porous polyolefin sheet having a three-layered structure of PP/PE/PP) having an air permeability of 300 sec according to a Gurley test method were prepared.

The produced positive electrode sheet and the negative electrode sheet were opposed to each other, with the separator sheets interposed therebetween, to produce an electrode body.

Current collectors were attached to the produced electrode body, and the electrode body was housed and sealed together with the non-aqueous electrolytic solution of each Example and each Comparative Example in a laminate case. Thus, lithium ion secondary cells for evaluation were produced.

Initial Charging and Initial Evaluation

Each of the produced lithium ion secondary cells for evaluation was placed in a thermostatic chamber of 25° C. Each lithium ion secondary cell for evaluation was constant-current charged at a current value of 0.3 C to 4.10 V as initial charging, and then constant-current discharged at a current value of 0.3 to 3.00 V. Next, after constant-current charging with a current value of 0.2 C to 4.10 V, constant-voltage charging was performed until the current value became 1/50 C, so that a fully charged state was reached. Thereafter, constant-current discharging was performed at a current value of 0.2 C to 3.00 V. The discharge capacity at this time was measured, and the measurement result was used as the initial capacity. Further, the initial volume of each lithium ion secondary cell for evaluation was measured by the Archimedes method using a Fluorinert as a solvent.

High-Temperature Storage Test

Each lithium ion secondary cell for evaluation described above was charged at a current value of 0.3 C to a SOC of 100%, and then stored in a thermostatic chamber at 60° C. for 1 month. The discharge capacity of each lithium ion secondary cell for evaluation was measured by the same method as described above, and the discharge capacity at this time was determined as the cell capacity after high-temperature storage. A capacity retention ratio (%) was determined as (cell capacity after high-temperature storage/initial capacity)×100. The relative capacity retention ratio of each Example and Comparative Example 2 was determined by taking the capacity retention ratio of Comparative Example 1 as 100. The results are shown in Table 1.

Moreover, the volume (volume after high-temperature storage) of each lithium ion secondary cell for evaluation was measured by the same method as described hereinabove. The volume increase amount was determined from the difference between the volume after the high-temperature storage and the initial volume. This volume increase amount corresponds to the amount of generated gas. The relative amount of generated gas (volume increase amount) of each Example and Comparative Example 2 was determined by taking the amount of generated gas (volume increase amount) in Comparative Example 1 as 100. The results are shown in Table 1.

TABLE 1

| | | Addition | | Addition | Relative | Relative capacity |
|---|---|---|---|---|---|---|
| | | amount (% | | amount (% | amount of | retention ratio after high- |
| | Additive | by mass) | FEC | by mass) | generated gas | temperature storage |
| Comparative | None | 0 | Not | 0 | 100 | 100 |
| Example 1 | | | added | | | |
| Example 1 | (A) | 0.5 | | 0 | 62 | 98 |
| Example 2 | | 1.0 | | 0 | 54 | 93 |
| Example 3 | | 1.5 | | 0 | 46 | 86 |
| Example 4 | (B) | 0.5 | | 0 | 62 | 103 |
| Example 5 | | 1.0 | | 0 | 73 | 96 |
| Example 6 | | 1.5 | | 0 | 84 | 90 |
| Comparative | None | 0 | Added | 10 | 180 | 115 |
| Example 2 | | | | | | |
| Example 7 | (A) | 0.5 | | | 110 | 117 |
| Example 8 | | 1.0 | | | 98 | 113 |
| Example 9 | | 1.5 | | | 87 | 110 |
| Example 10 | (B) | 0.5 | | | 108 | 118 |
| Example 11 | | 1.0 | | | 113 | 111 |
| Example 12 | | 1.5 | | | 123 | 105 |

From the comparison of Comparative Example 1 with Examples 1 to 6 and the comparison of Comparative Example 2 with Examples 7 to 12, it can be understood that by adding 2,3-pyridinedicarboxylic acid anhydride or 3,4-thiophenedicarboxylic acid anhydride, the amount of generated gas can be significantly reduced. Further, it is understood that 2,3-pyridinedicarboxylic acid anhydride including an N atom in a hetero ring is more effective in suppressing gas generation than 3,4-thiophenedicarboxylic acid anhydride including an S atom in a hetero ring. It is understood that the capacity retention ratio can be increased by adding FEC.

The heteroaromatic dicarboxylic acid anhydride used above is less toxic than common isocyanate compounds. Therefore, it is understood from the above that according to the present embodiment described hereinabove, it is possible to provide a non-aqueous electrolytic solution that uses an additive that can suppress gas generation due to the decomposition of the non-aqueous electrolytic solution and has a low environmental risk.

Although the specific examples of the present teaching have been described above in detail, these are merely examples and do not limit the scope of the claims. The art set forth in the claims includes various changes and modifications of the specific examples illustrated above.

What is claimed is:

1. A method for suppressing gas generation due to decomposition of a non-aqueous electrolytic solution for a lithium ion secondary cell, the method comprising:
using a non-aqueous electrolytic solution in a lithium ion secondary cell, wherein the non-aqueous electrolytic solution comprises:
an electrolyte salt including a fluorine atom;
ethylene carbonate, dimethyl carbonate, and ethyl methyl carbonate as a non-aqueous solvent capable of dissolving the electrolyte salt,
8% by mass or more and 20% by mass or less of fluoroethylene carbonate, and
at least one heteroaromatic dicarboxylic acid anhydride selected from the group consisting of 2,3-pyridinedicarboxylic acid anhydride and 3,4-thiophenedicarboxylic acid anhydride as an additive.

2. The method according to claim 1, wherein the heteroaromatic dicarboxylic acid anhydride is 2,3-pyridinedicarboxylic acid anhydride.

3. The method according to claim 1, wherein a volume ratio of ethylene carbonate:dimethyl carbonate:ethyl methyl carbonate is 30:40:30.

4. The method according to claim 3, wherein the electrolyte salt is LiPF₆, and a concentration of LiPF₆ is 1.0 mol/L.
